(19) United States
(12) Patent Application Publication
(10) Pub. No.: US 2025/0289296 A1
(43) Pub. Date: Sep. 18, 2025

(54) SUN VISOR FOR A MOTOR VEHICLE

(71) Applicant: Ford Global Technologies, LLC, Dearborn, MI (US)

(72) Inventor: Piotr Politowicz, Leverkusen (DE)

(73) Assignee: Ford Global Technologies, LLC, Dearborn, MI (US)

(21) Appl. No.: 19/036,147

(22) Filed: Jan. 24, 2025

(30) Foreign Application Priority Data
Mar. 14, 2024 (DE) 102024107231.8

(51) Int. Cl. B60J 3/02

(52) U.S. Cl. CPC B60J 3/026

(57) ABSTRACT

A sun visor for a motor vehicle. The sun visor has a base body with wide sides extending in a vehicle transverse direction and narrow sides arranged at an angle to the wide sides, wherein the base body is in communication with a fastening element via a movement element. A fastening element is configured to be fastened to a component of the motor vehicle in a positionally stable manner. The base body has an actuating mechanism which is operatively connected to a transmission element which extends towards the movement element and is connected to the movement element.

### CROSS-REFERENCE TO RELATED APPLICATION

This application claims foreign priority benefits under 35 U.S.C. § 119 (a)-(d) to German Application No. 102024107231.8 filed Mar. 14, 2024, which is hereby incorporated by reference in its entirety.

### FIELD OF THE DISCLOSURE

The present disclosure generally relates to sun visors for motor vehicles, and more particularly relates to an actuatable sun visor.

### BACKGROUND OF THE DISCLOSURE

Sun visors for motor vehicles are commonly provided in vehicle interiors and are frequently installed on a headliner of the vehicle on a swing hinge and used to prevent sunlight from shining into the vehicle interior from the outside. As viewed in the vehicle transverse direction, a clamping assembly may be provided at a spacing from the swing hinge. If the sun visor is fixed to the clamping assembly, the sun visor may only be swiveled horizontally. If the sun visor is released from the clamping assembly, the sun visor may also swivel laterally to the right or left, depending on whether the sun visor is fastened on the driver's side or on the passenger's side.

In some vehicles, installation of the clamping assembly in areas beside the center of the vehicle may be desired. In such a case, the sun visor is typically held at one fastening point so that it can be transferred into, and held in, the desired position in a positionally stable, undisturbed and also rattle-free manner.

It would be desirable to provide for a sun visor for a motor vehicle such that, even with only one fastening point, the sun visor is held stable and effectively offers sufficient movement control.

### SUMMARY OF THE DISCLOSURE

According to a first aspect of the present disclosure, a sun visor for a motor vehicle has a base body with wide sides extending in a vehicle transverse direction and narrow sides arranged at an angle to the wide sides. A fastening element is configured to be fastened to a component of the motor vehicle in a positionally stable manner. A movement element is coupled to the base body and the fastening element. An actuating mechanism is provided on the base body. A transmission element is operatively connected to the actuating mechanism. The transmission element is guided on the base body and extends towards the movement element and is connected to the movement element.

Embodiments of the first aspect of the present disclosure can include any one or a combination of the following features:
the actuating mechanism is arranged on one of the narrow sides of the base body arranged opposite the movement element, wherein the transmission element, guided on the base body, extends along one of the narrow sides and one of the wide sides towards the movement element and is connected to the movement element;
the movement element is connected to the fastening element such that the movement element is movable relative to the fastening element and is connected to the base body;
the movement element has a plurality of movement axes, wherein two of the movement axes are aligned at a perpendicular angle;
the movement element has a housing with a housing portion, wherein the housing has a rotating sleeve in one housing portion and a rotating element in another housing portion;
the one housing portion of the housing which houses the rotating element is connected to the fastening element;
the movement element has an end stop on a side of a movement-element side, which end stop has a groove and receptacles on its outer wall and is in displaceable communication with the transmission element;
the movement element has locking elements which cooperate with an end stop on the movement-element side;
the transmission element is fixed to an end stop on an actuating-mechanism side by an end which is oriented towards the actuating mechanism and to an end stop on the movement-element side by its end which is oriented towards the movement element; and
the transmission element has, at an end which is oriented towards the actuating mechanism, an energy-storage mechanism in the form of a spring element and at the end which is oriented towards the movement element, likewise an energy-storage element, wherein the energy-storage element on the actuating-mechanism side is arranged between two spring abutments, and wherein the energy-storage mechanism on the movement-element side abuts against an end stop on the movement-element side and a spring abutment.

According to a second aspect of the present disclosure, a sun visor for a motor vehicle has a base body with wide sides extending in a vehicle transverse direction and narrow sides arranged at an angle to the wide sides. A fastening element is configured to be fastened to a component of the motor vehicle in a positionally stable manner. A movement element is connected to the fastening element. The movement element is movable relative to the fastening element and is connected to the base body and has a plurality of movement axes. Two of the movement axes are aligned at a perpendicular angle. An actuating mechanism is provided on the base body arranged on one of the narrow sides of the base body arranged opposite the movement element. A transmission element is operatively connected to the actuating mechanism. The transmission element is guided on the base body and extends towards the movement element and is connected to the movement element. The transmission element, guided on the base body, extends along one of the narrow sides and one of the wide sides towards the movement element and is connected to the movement element.

Embodiments of the second aspect of the present disclosure can include any one or a combination of the following features:
the movement element has a housing with a housing portion, wherein the housing has a rotating sleeve in one housing portion and a rotating element in another housing portion;
the one housing portion of the housing which houses the rotating element is connected to the fastening element;
the movement element has an end stop on a side of a movement-element side, which end stop has a groove and receptacles on its outer wall and is in displaceable communication with the transmission element;
the movement element has locking elements which cooperate with the end stop on the movement-element side; and
the transmission element is fixed to an end stop on an actuating-mechanism side by an end which is oriented towards the actuating mechanism and to the end stop on the movement-element side by its end which is oriented towards the movement element.

According to a third aspect of the present disclosure, a motor vehicle has a vehicle body component and a sun visor. The sun visor has a base body with wide sides extending in a vehicle transverse direction and narrow sides arranged at an angle to the wide sides. A fastening element is configured to be fastened to the vehicle body component of the motor vehicle in a positionally stable manner. A movement element is coupled to the base body and the fastening element. An actuating mechanism is provided on the base body. A transmission element is operatively connected to the actuating mechanism. The transmission element is guided on the base body and extends towards the movement element and is connected to the movement element.

Embodiments of the third aspect of the present disclosure can include any one or a combination of the following features:
the actuating mechanism is arranged on one of the narrow sides of the base body arranged opposite the movement element, wherein the transmission element, guided on the base body, extends along one of the narrow sides and one of the wide sides towards the movement element and is connected to the movement element;
the movement element is connected to the fastening element such that the movement element is movable relative to the fastening element and is connected to the base body; and
the movement element has a plurality of movement axes, wherein two of the movement axes are aligned at a perpendicular angle.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a perspective view of a sun visor according to one embodiment, in which the front side is not visible;

FIG. 1A is a perspective view of the sun visor in FIG. 1 in an overall view;

FIG. 2 is a perspective view of the sun visor in FIG. 1 in a usage position;

FIG. 3 is a cross-sectional view showing the movement element along the section line A of FIG. 1;

FIG. 3A is an enlarged view of the end stop on the movement-element side, which end stop is shown in FIG. 3; and

FIG. 4 is a cross-sectional view showing the movement element along the section line B of FIG. 1.

### DETAILED DESCRIPTION OF PREFERRED EMBODIMENTS

Reference will now be made in detail to the present preferred embodiments of the disclosure, examples of which are illustrated in the accompanying drawings. Wherever possible, the same reference numerals will be used throughout the drawings to refer to the same or like parts. In the drawings, the depicted structural elements are not to scale and certain components are enlarged relative to the other components for purposes of emphasis and understanding.

As required, detailed embodiments of the present disclosure are disclosed herein; however, it is to be understood that the disclosed embodiments are merely exemplary of the disclosure that may be embodied in various and alternative forms. The figures are not necessarily to a detailed design; some schematics may be exaggerated or minimized to show function overview. Therefore, specific structural and functional details disclosed herein are not to be interpreted as limiting, but merely as a representative basis for teaching one skilled in the art to variously employ the present disclosure.

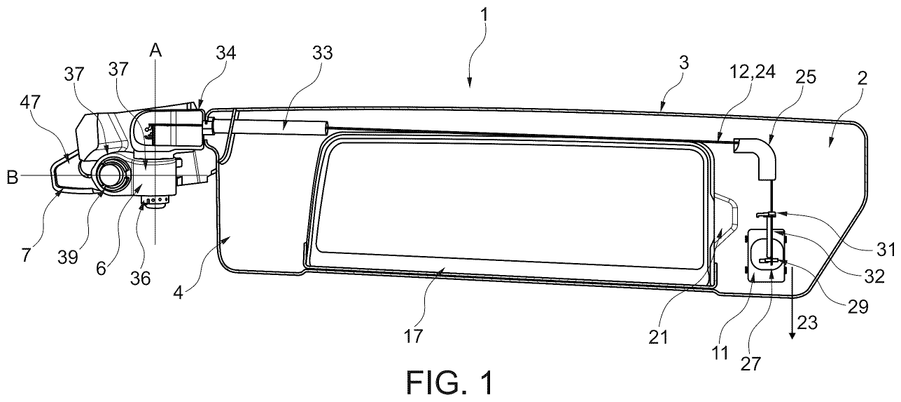

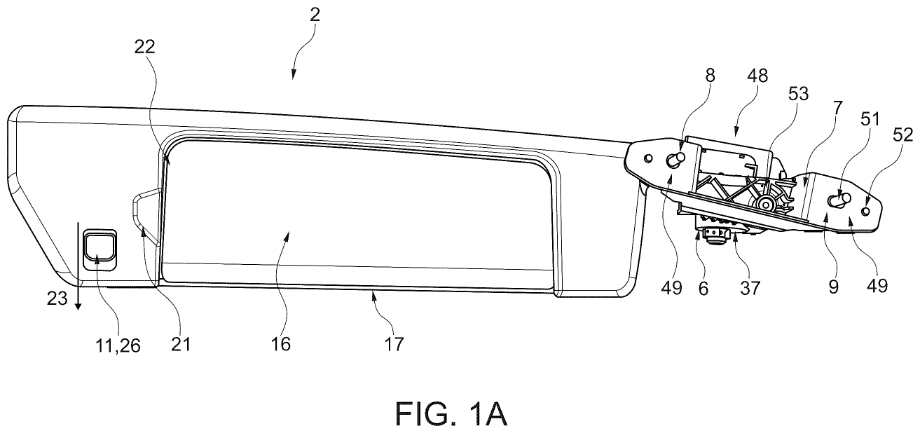

For purposes of description herein, the terms “upper,” “lower,” “right,” “left,” “rear,” “front,” “vertical,” “horizontal,” and derivatives thereof shall relate to the concepts as oriented in FIG. 1. However, it is to be understood that the concepts may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The present illustrated embodiments reside primarily in combinations of method steps and apparatus components related to a sun visor for a motor vehicle. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

As used herein, the term “and/or,” when used in a list of two or more items, mechanism that any one of the listed items can be employed by itself, or any combination of two or more of the listed items, can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

The present application may refer to amounts and numbers. Unless expressly stated otherwise, such amounts and numbers should not be considered limiting but should be considered examples of the possible amounts or numbers in the context of the present application. In this context, the present application might also use the phrase “a plurality of” in order to refer to an amount or number. In this context, the phrase “a plurality of” should be in any number greater than one, e.g., two, three, four, five, etc. The terms “around”, “approximately”, “near”, etc. mean plus or minus 5% of the value specified.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

Equivalent parts are always denoted by the same reference signs in the figures and are therefore generally only described once.

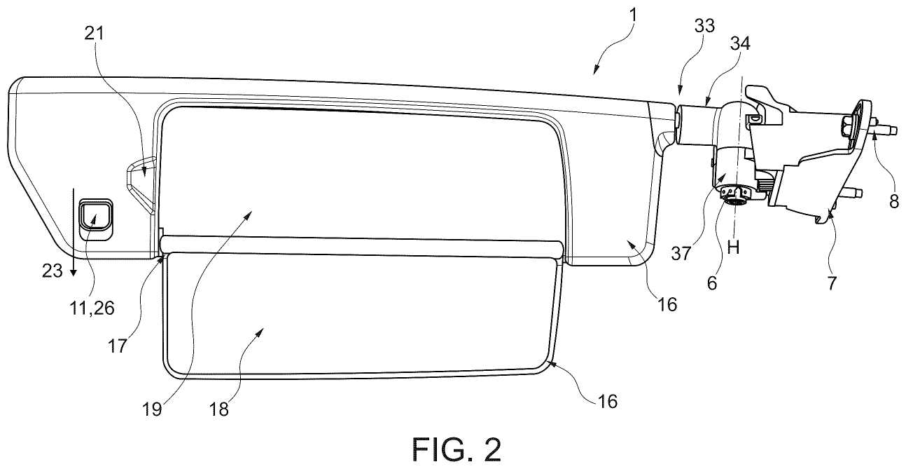

FIGS. 1 and 1A show a sun visor 1 for a motor vehicle. The sun visor 1 has a base body 2 having wide sides 3 extending in the vehicle transverse direction Y and narrow sides 4 arranged at an angle to said wide sides. As can be seen in FIGS. 1 and 1A, the base body 2 has two mutually opposing wide sides 3 and two mutually opposing narrow sides 4. By way of example, the narrow sides 4 are arranged at a 90° angle to the wide sides 3. The base body 2 is designed to be wider, as seen in the transverse direction of the drawing planes of FIGS. 1 to 2, than it is narrow, as seen in the vertical direction, although this is merely by way of example.

In the view of a front side of the sun visor 1 as selected in FIG. 1, a pad on the front side is removed in order to obtain a view of the interior of the sun visor 1. In the view selected in FIG. 1A, the pad 13 can be seen; however, the interior is covered thereby.

As can furthermore be seen in FIGS. 1 and 1A, the base body is in communication with a fastening clement 7 via a movement element 6. The fastening element 7 is fastened to a component of the motor vehicle in a positionally stable manner, as indicated in FIG. 1A by the screw shafts 8 illustrated by way of example. In one configuration, the fastening element 7 may be fastened to a vehicle body component of the motor vehicle, e.g., to an A-pillar or in the vicinity thereof on a headliner. The fastening element 7 might also be bonded to a windshield or to other vehicle body components by its fastening side 9, which can be seen in FIG. 1A.

The movement element 6 may be in the form of a hinged joint and is in communication with the fastening element 7 such that it is movable relative thereto on the one hand and to the sun visor 1, particularly to the base body 2 thereof, on the other.

As can furthermore be seen in FIGS. 1 and 1A, the base body 2 has, on its narrow side 4 arranged opposite the movement element 6, an actuating mechanism 11, which is operatively connected to a transmission element 12 which extends along the narrow side 4 and the wide side 3 towards the movement element 6 and is connected to this latter.

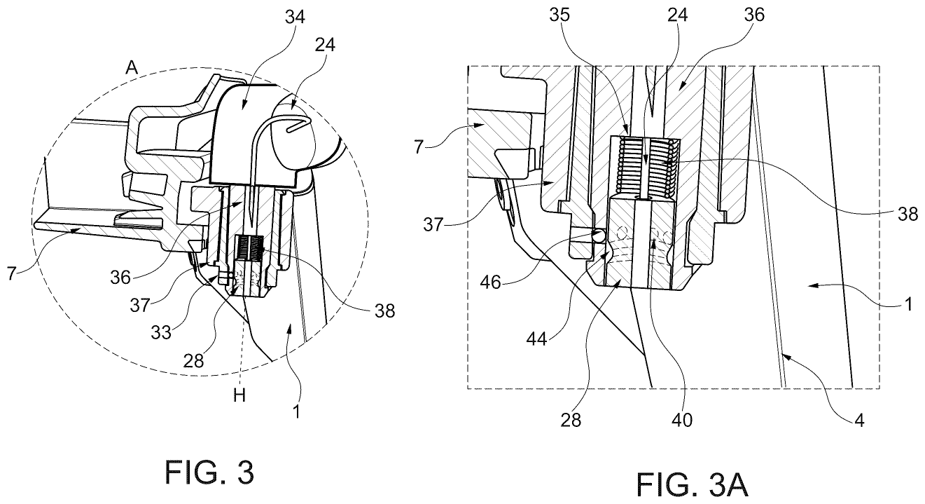

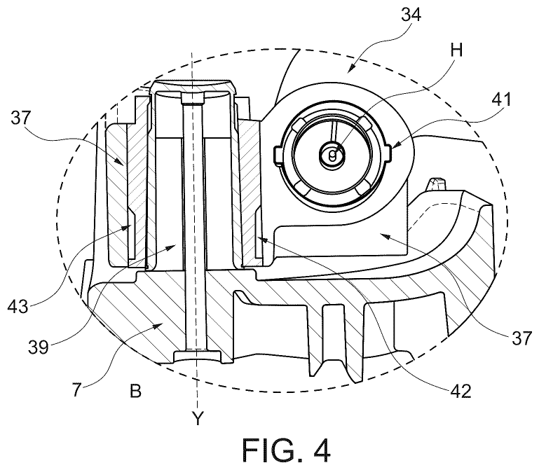

In one configuration, the movement clement 6 has a locking mechanism, wherein the transmission element 12 is in communication with the locking mechanism. The locking mechanism can be seen most clearly in FIGS. 3 and 4, which show sections along the second lines A and B of FIG. 1A.

The movement element 6 may be released or blocked by use of the locking mechanism. If the movement element 6 is released, the sun visor I may be transferred from an idle position into a usage position. If the movement element 6 is blocked, a non-swiveling secured position may be ensured even in the case of extreme events. In other words, the sun visor 1 maintains its position when the movement element 6 is blocked.

In the idle position, the sun visor 1, particularly the base body 2 thereof, is folded away out of the driver's field of view. In an ideal configuration, the sun visor 1, particularly the base body 2 thereof, has a plurality of usage positions, which may, however, also be adjusted continuously along an imaginary horizontal swivel axis as seen in the lateral direction. The sun visor 1, in the respective usage position, may therefore protect the driver from frontal sunlight and also from glare from oncoming vehicles. The sun visor 1, particularly the base body 2 thereof, may furthermore not only be adjusted in terms of its horizontal angle, but also laterally, in order to protect against lateral glare.

The sun visor 1 further has a manually actuable extension 16, which, in the state illustrated in FIGS. 1 and 1A in each case, is folded upwards. The extension 16 may be folded out along a swivel axis 17 in the region of the lower wide side 3 arranged in the drawing plane of FIG. 1 and thus extends the glare-protection area of the sun visor 1. A mirror 18 may be arranged on the extension 16, in particular on the inner side thereof, which mirror may possibly be illuminated. The folded-out position 14 is illustrated in FIG. 2.

It can further be seen in FIG. 2 that the extension 16 is received in a corresponding cutout 19 both in the base body 2 and in the pad 13 thereof. The cutout 19 is adapted to the configuration of the extension 16, so that this latter is received virtually flush in the sun visor 1, particularly in the base body 2 thereof, when the extension 16 is folded upwards. By usage of the recessed grip 21, which, as can be seen by way of example, is arranged on a narrow side 22 of the extension 16 in the base body 2, the extension 16 is easy to grip and can be folded downwards or out from the upwardly folded position via the swivel axis 17.

To release the locking mechanism of the movement element 6, the actuating mechanism 11 is actuated, wherein the actuating mechanism 11 is moved in the direction of the arrow 23, i.e. towards the lower wide side 3, which can be seen in the drawing plane of FIGS. 1 and 1A. As a result, the transmission element 12 is likewise deflected and thus actuates the locking mechanism so that the movement element 6 is released and is rotatable. So long as the actuating mechanism 11 is held in its deflected position, the movement element 6 remains released so that the sun visor 1 can be transferred freely and continuously into any position. Only when the actuating mechanism 11 is released does this bring about a blocking of the movement element 6, so that the above-mentioned secured position is established.

As already described above, the actuating mechanism 11 is connected to the movement clement 6 via the transmission element 12.

In an effective configuration, the transmission element 12 is in the form of a cable pull. A cable pull 24 here is received in a pressure-resistant sleeve, at least in sections, as can be seen in FIG. 1. The transmission element 12 may therefore also be displaced in a locally positionally stabilized manner, even with changes of direction, as can be seen in FIG. 1. By way of example, starting at an end stop 27, the transmission element, e.g., the cable pull 24 thereof, extends parallel to the narrow side 4 from the actuating mechanism 11 towards the wide side 3, changes direction through 90° in the vicinity of the wide side 3 and is further guided parallel to the wide side 3 towards the movement element 6, where it is in communication with an end stop 28 (FIG. 3). The change of direction is promoted by an angle element 25 in which the cable pull 24 is guided. The transmission element 12 here may be arranged within the base body 2 and fastened to its base body framework. The transmission element 12 is therefore displaced in a virtually non-visible manner. Only the actuating mechanism 11 in the form of the deflectable slide button 26 with the recessed grip is visible, wherein the slide button 26 is arranged on a visible, rigid slide plate.

A spring abutment 29, by use of which the cable pull 24 is guided, is arranged internally on the actuating mechanism 11, i.e. on the movable element thereof, as can be seen in FIG. 1. The end stop 27 on the actuating-mechanism side abuts against the spring abutment 29 and is therefore in direct communication with the actuating mechanism 11, i.e. it is attached thereto. The cable pull 24 is therefore also connected directly to the actuating mechanism 11. As seen in the drawing plane of FIG. 1, a further spring abutment 31 is arranged above the spring abutment 29 on the actuating-mechanism side. An energy-storage mechanism 32, such as in the form of a helical spring, is arranged between the two spring abutments 29, 31. The end stop 27 on the actuating-mechanism side abuts against the spring abutment 29 on the actuating-mechanism side, opposite the contact with the spring element.

On the movement-element side, the cable pull 24 is guided into the movement element 6 via an insertion element 33 (FIG. 1) and fixed to the end stop 28, The insertion element 33 is in direct but rotatable communication with the movement arm 34 of the movement element 6. The sun visor 1 is rotatable about the longitudinal axis of the insertion element 33.

The end stop 28 is arranged in a rotating sleeve 36, which is received in a housing 37 of the movement element 6 (FIG. 3). An axis of rotation H of the rotating sleeve 36 is aligned parallel to the vertical direction (FIG. 2). The end stop 28 is in communication with an energy-storage mechanism 38, e.g., a helical spring, on the movement-element side. On the side opposite this, the energy-storage mechanism 38 abuts against an internal projection 35 (FIG. 3A) of the rotating sleeve 36. The end stop 28 on the movement-element side is arranged with its center axis congruent with the axis of rotation H of the rotating sleeve 36 and may move relative thereto along its center axis. A rotating element 39 is, moreover, arranged in the housing 37 of the movement element 6. An axis of rotation Y (FIG. 4) of the rotating element 39 is aligned perpendicularly to the axis of rotation H of the rotating sleeve 36. The movement arm 34 is in direct contact with the rotating sleeve 36.

To prevent a rotation of the rotating element 39 and the rotating sleeve 36 with respect to the housing 37, spline connections 41, 42 and 43 are provided.

The end stop 38 on the movement-element side has a circumferential groove 44, whereof the groove walls are inclined in contrary directions towards the groove base. This can be seen most clearly in FIG. 3A. Locking elements 46 are arranged between the outer wall of the end stop 28 on the movement-element side and the inner wall of the rotating sleeve 36. The locking elements 46 abut against the outer wall of the end stop 28 with frictional engagement and/or non-positive engagement on the one hand and project out of a corresponding cutout in the inner wall of the rotating sleeve 36. In addition, in the circumferential direction of the end stop 28 on the movement-element side, discontinuous receptacles 40 are arranged in the outer wall of the end stop 28, in which receptacles the locking elements 46 engage so that non-positive engagement is realized in addition to the frictional engagement. The level of frictional engagement, and also the depth of the receptacle 40 in the outer wall, is set such that a rotation of the rotating sleeve 36 is prevented when the locking elements 46 abut with their contact surface against the outer wall, e.g., in the receptacles 40 of the end stop 28, such that they contact this end stop. As can be seen in FIG. 3A, the receptacles 40 are arranged higher in their drawing plane than the groove 44. If, owing to the effect of the transmission element 12, by pulling the actuating mechanism 11 downwards in the direction of the arrow 23 in the drawing plane of FIGS. 1 and 1A, the end stop 28 on the movement-element side is now deflected upwards in opposition to the spring energy of the energy-storage mechanism 38 in the drawing plane of FIG. 3A, the locking elements 46 slide out of the receptacles 40 into the groove 44 and enable the rotational movement of the rotating sleeve 36 since the frictional and/or non-positive contact is removed. In an ideal configuration, the groove, and also the receptacles 40, are dimensioned such that the locking elements 46 may slide against the inclined groove walls, wherein the groove base is then at a spacing from the contact surface of the locking element 46. In particular, the receptacles 40 are designed such that the resultant force with which the end stop 28 on the movement-element side is moved upwards in the drawing planes of FIGS. 3 and 3A is greater than the level of frictional engagement and/or the level of non-positive engagement with which the locking elements 46 are held in the receptacles 40, so that these may slide out of the receptacles 40 and into the groove 44. However, the level of frictional engagement and/or non-positive engagement is, in particular, greater than the force of a possible extreme event, so that the blocking of the movement element 6 is still maintained and is only released upon the actuation of the actuating mechanism 11. Instead of receptacles 40 that are discontinuous in the circumferential direction, a continuous contact groove may also be provided; however this is adapted to the above-mentioned conditions. In particular, this contact groove, like the receptacles 40, has a smaller depth than the groove 44. The advantages of a contact groove can be seen in the freedom of the locking elements 46 to engage in the circumferential direction, wherein, as a result of the frictional engagement and/or non-positive engagement.

The locking elements 46 might also be acted upon by spring energy. A spring may be arranged on the end of the locking elements that is arranged in the rotating sleeve 36, which spring pushes the locking elements 46 against the contact surface of the end stop 28 on the movement-element side, i.e. into the receptacles or into the contact groove, with their free end which exits the rotating sleeve 36. Therefore, when the movement element 6 is blocked, the position can be better secured. The spring energy, in conjunction with the configuration of the locking element 46 and the receptacle 40 or contact groove, can in turn be dimensioned such that the blocking of the movement element is still maintained even in the case of extreme events and reduce any uncontrolled knocking back and forth about the vertical axis H.

The sun visor 1, particularly the base body 2 thereof, may therefore be moved out of the idle position into the respective usage position, and back again, in that the actuating mechanism 11 is simply deflected and thus held. If the actuating mechanism 11 is released, it returns to the starting position due to the spring energy. The end stop 28 on the movement-element side is also moved back into its starting position due to the spring energy. During this, the locking elements slide with the contact surface along the inclined groove walls and then into the receptacles 40 and establish the frictional and/or non-positive contact with the outer wall of the end stop 28 again so that the rotational movement is blocked and the positionally stable movement block, which is also desired in extreme situations, is active again.

Through a rotation of the rotating element 39 about the axis of rotation Y, the user may adjust the position of the spacing between the sun visor 1 and the surface of a windshield of the vehicle. The sun visor 1 may be rotated about the longitudinal axis of the insertion element 33. This movement enables the user to set the protection from sunlight, to increase the angle of vision or to transfer the sun visor more easily into the idle or usage position.

As can be seen in FIGS. 1 and 1A, the fastening element 7 is designed in the manner of a plate with a fastening side 9 and a holding side 47 opposite said fastening side 9. By way of example, the fastening element 7 has an elongated design and has, at its ends, respective fastening protrusions 49 arranged in a central area 48. The fastening protrusions 49 project with the same orientation out of the plane of the central area 48 and have openings 51 and positioning elements 52, which latter are arranged on the fastening side 9, although they are oriented away from the central area 48 in opposite directions in each case. The fastening sides 9 of the fastening protrusions 49 are in turn arranged on a common plane. Screws, of which the screw shafts 8 can be seen, are fed through the openings 51. The positioning elements 52 may engage in corresponding cutouts in the component of the motor vehicle. To stabilize the fastening element 7, elevations 53, preferably web-like elevations, which may also cross one another or which may be arranged concentrically around the openings 51, may be provided. A particularly positionally stable fastening of the sun visor 1 is therefore achieved by a single fastening element 7 via the two fastening protrusions 49. The movement clement 6 is fixed in the central area 48 on the holding side. The housing portion of the housing 37 which houses the rotating element 39 is in contact with the fastening element 7 here. The housing portion of the housing 37 which houses the rotating sleeve 36 does not contact the fastening element 7.

In one configuration, the fastening element 7 may be made of plastic, for example, and, in this regard, can be produced with the required stability in an efficient manner. Fastening elements 7 which are made of metal or a composite material are also possible, according to other examples.

The present disclosure provides a sun visor for a motor vehicle, having a base body with wide sides extending in the vehicle transverse direction and narrow sides arranged at an angle to the wide sides, wherein the base body is in communication with a fastening element via a movement element, wherein the fastening element is fastened to a component of the motor vehicle in a positionally stable manner. The base body has an actuating mechanism, which is operatively connected to a transmission element which, guided on the base body, extends towards the movement element and is connected to this latter.

It should be pointed out that the features and measures listed individually in the description below may be combined with one another in any technically meaningful manner and demonstrate further configurations of the disclosure. The description additionally characterizes and specifies the sun visor in particular in conjunction with the figures.

Motor vehicles within the context of the disclosure may be automobiles, buses, flatbed trucks, etc., wherein battery-operated vehicles, hybrid vehicles or vehicles with other drives shall be included.

The disclosure demonstrates a sun visor which is fastened at only one fastening point, which is held stable at all times and which always offers sufficient movement control. By mechanism of the disclosure, transfer from the idle position into the usage position or from the usage position into the idle position, i.e. an uncontrolled knocking back and forth, in particular in extreme situations, is ruled out.

In a favorable configuration, the base body may have the actuating mechanism on its narrow side arranged opposite the movement element, wherein the transmission element, guided on the base body, extends along the narrow side and the wide side towards the movement element and is connected to this latter.

In one configuration, the fastening element is designed in the manner of a plate with a fastening side and a holding side opposite said fastening side. In one configuration, the fastening element has an elongated design and has, at its ends, respective fastening protrusions arranged in a central area. It is advantageous if the fastening protrusions have openings and positioning elements, which latter are arranged on the fastening side. Screws, which can be screwed into corresponding counter-threads in the component of the motor vehicle, may be fed through the openings. The positioning elements may engage in corresponding cutouts in the component of the motor vehicle. To install the fastening element, the positioning elements may firstly engage in the corresponding cutouts, wherein the fastening screws are then screwed into the corresponding counter-thread in the component of the motor vehicle. In this way, a particularly secure and predominantly planar, elongated connection with the component is produced, which contributes advantageously to the positional stability of the sun visor in the different positions. The fastening element is fastened to the component of the motor vehicle in a positionally stable manner by the fastening side. To stabilize the fastening element, elevations, preferably web-like elevations, which may also cross one another or which may be arranged concentrically around the openings, may be provided, at least on the fastening side thereof. These structures, which may also be referred to as a reinforcing structure, may also serve to enable even better fastening of the fastening element. Moreover, the material of the fastening element is reduced, as is its weight. In this exemplary configuration, the fastening element may be screwed, i.e. fastened, to an A-pillar or in the vicinity thereof. However, it is also conceivable to bond the fastening element to the component of the motor vehicle by its fastening side. At least the openings for the screw shafts and possibly the positioning elements would then be unnecessary. By way of example, the fastening clement (without a positioning element) might be bonded to a windshield or the fastening element (with a positioning element) might be bonded to the A-pillar or in the vicinity of the A-pillar on a roof panel. In a further favorable configuration, one idea is to design the positioning element with a somewhat greater diameter than the cutouts so that the positioning elements, overcoming a resistance, may still be pushed into the recesses so that a first secured position of the fastening element is achieved when the alignment is reached. The final assembly is therefore facilitated.

Configurations in which the movement element is connected to the fastening element and is likewise connected to the base body of the sun visor are favorable. In this way, the sun visor may be held in a particularly positionally stable manner, wherein the necessary movement control and desired adjustability thereof is, moreover, realized when the actuating mechanism is actuated accordingly.

In an effective configuration, the movement clement is lockable so that the movement clement is released or blocked in terms of its movability. If the movement element is released, the sun visor, particularly the base body thereof, may be adjusted continuously from its idle position into any usage position and returned to the idle position again. By blocking the movement element, the desired position may be held in a stable manner, wherein even extreme events or braking and accelerating procedures do not have any influence on the set and locked position.

In an expedient configuration, the movement element has a plurality of movement axes, so that the sun visor, particularly the base body thereof, may be adjusted continuously from the idle position into any usage position and returned to the idle position again. It is advantageous here if two of the movement axes are aligned at an angle, in particular perpendicularly, to one another. In the installed state of the sun visor, one of the movement axes is aligned in the vertical direction of the vehicle. In the installed state of the sun visor, another of the movement axes is aligned perpendicularly to the previously mentioned movement axis. A movement of the sun visor in the vertical direction about the movement axis enables the sun visor, particularly the base body thereof, to be transferred from the idle position into a usage position, and back again. This movement axis can be blocked. A movement of the sun visor about the other movement axis enables the sun visor, particularly the base body thereof, to be positioned relative to a windshield. This enables the spacing between the base body and the windshield to be adjusted. Moreover, the sun visor, i.e. the base body, may still be adjusted about a longitudinal axis of a guide mechanism of the transmission element. This longitudinal axis extends, in particular, parallel to the wide side of the base body. The glare protection from sunlight and from oncoming traffic and the angle of vision may therefore be adjusted, in particular increased, and the transfer from the idle position into one of the usage positions, and vice versa, is facilitated.

In an ideal configuration, the transmission element is connected to the movement element on the one hand and to the actuating mechanism on the other. The movement element can therefore be released or blocked via the actuating mechanism. To this end, in one configuration, the actuating mechanism can be transferred manually from a starting position into a deflected position and secured manually there. Through the actuation of the actuating mechanism, e.g., through the deflection thereof out of its starting position, the transmission element is also deflected accordingly with its end facing the actuating mechanism so that the movement element is released. To this end, a locking mechanism, in particular, is arranged on the movement clement, which locking mechanism brings about the release by the actuating mechanism via the transmission element. If the actuating mechanism is not actuated, the movement element is blocked.

In one configuration, the movement element has a housing, which houses a rotating sleeve in one housing portion and a rotating element in another housing portion. The housing portion of the housing that houses the rotating element is connected directly to the fastening clement. In particular, the rotating sleeve may be blocked or released in terms of its rotational movement. In particular, an end stop on the movement-element side has a groove on its outer wall, in which locking elements engage so that the rotating sleeve is released in terms of its rotation, which locking elements are arranged on the rotating sleeve and previously contacted the outer wall of the end stop with frictional engagement and/or non-positive engagement. If the locking elements contact the outer side of the end stop, the rotating sleeve is blocked. The end stop on the movement-element side is displaced, in particular, through the action of the transmission element and returned due to the energy-storage mechanism. Together with the end stop on the movement-element side, the locking elements form a locking mechanism.

In one configuration, the transmission element extends within the base body of the sun visor so that it is not visible. In one configuration, it may be provided here that the transmission element extends parallel to the narrow side from the actuating mechanism towards the wide side, changes direction here through about 90°, for example, and is guided parallel to the wide side towards the movement element, where it is connected to the locking mechanism thereof, in particular to the end stop on the movement-element side.

In one configuration, the transmission element may be in the form of a cable pull, which cable pull is arranged in a pressure-resistant sleeve. The transmission element may also be referred to as a Bowden cable. The transmission element, e.g., the cable pull thereof, is fixed to an end stop by its end which is oriented towards the actuating mechanism. The transmission clement is likewise fixed to the end stop on the movement-element side by its end which is oriented towards the movement element. For the guidance of the transmission element, the pressure-resistant sleeve may be used as a guide mechanism. The pressure-resistant sleeve here is advantageously discontinuous in the direction of extent of the transmission element, e.g., the cable pull, i.e. it is fixed to the base body in sections such that changes of direction and/or possibly some sections are positionally stabilized.

In a further configuration, the transmission element has, at its end which is oriented towards the actuating mechanism, an energy-storage mechanism, in particular in the form of a spring element. An energy-storage mechanism, e.g., a spring element, may likewise be arranged on the end which is oriented towards the movement element. The energy-storage mechanism on the actuating-mechanism side is arranged between two spring abutments. The energy-storage mechanism on the movement-element side abuts against an end stop on the movement-element side on the one hand and against a spring abutment of the rotating element on the other. Upon an actuation of the actuating mechanism, the energy-storage mechanism on the actuating mechanism side is stretched, wherein the energy-storage mechanism on the movement-element side is contracted. The end stop on the movement-element side is likewise displaced. The locking elements arrive in the groove of the end stop on the movement-element side so that the movement element is released. Upon the release of the actuating mechanism, an automatic, i.e. spring-energy-induced, return to the original position of the actuating mechanism is brought about, and therefore an automatic blocking of the movement element by the transmission element which has been transferred to the original position.

The use of a lock in the movement element, which may be formed as a swivel joint or hinge, may be proposed in order to prevent an unintentional movement of the sun visor in the respective position. Through the actuation of the actuating mechanism of the sun visor, the cable pull of the transmission element is pulled and the movement element, in particular the rotating sleeve thereof, is unlocked so that the user may rotate and adjust the sun visor. The cable pull is connected at one end to the actuating mechanism, which is movably fastened to the base body of the sun visor. Through the actuation of the actuating mechanism, the locking of the movement clement is removed, whereby the user may rotate and adjust the sun visor and bring it into the desired position.

In a further favorable configuration, an extension may be arranged on the base body, which extension increases the glare protection as needed. In an ideal configuration, the extension is in the form of a fold-down cover, which has a mirror on its inner side. The inner side here is the side of the extension which abuts against the base body in the state in which it is positioned against the base body. In one configuration, the extension is connected to the base body via a hinge; in one configuration, at a lower end of the base body. It is expedient if a depression is arranged in the base body, which depression is matched to the configuration of the extension. The extension may therefore be received virtually flush in the base body when the extension is folded against the base body. In order to be able to grip the extension more easily, a recessed grip, in particular, may be arranged on the base body. In an expedient configuration, the recessed grip may be arranged laterally on a narrow side of the extension.

The sun visor is also suitable for vehicles in which all radar devices, sensor modules and rearview mirrors are remote from the windshield. This disclosure enables the windshield to be free of obstacles and offers the occupants a better view of the sky, as is the case, for example, in jets.

It is to be understood that variations and modifications can be made on the aforementioned structure without departing from the concepts of the present disclosure, and further it is to be understood that such concepts are intended to be covered by the following claims unless these claims by their language expressly state otherwise.

What is claimed is:

1. A sun visor for a motor vehicle, the sun visor comprising:
a base body with wide sides extending in a vehicle transverse direction and narrow sides arranged at an angle to the wide sides;
a fastening element configured to be fastened to a component of the motor vehicle in a positionally stable manner;
a movement element coupled to the base body and the fastening element;
an actuating mechanism provided on the base body; and
a transmission element operatively connected to the actuating mechanism, wherein the transmission element is guided on the base body and extends towards the movement element and is connected to the movement element.

2. The sun visor according to claim 1, wherein the actuating mechanism is arranged on one of the narrow sides of the base body arranged opposite the movement element, wherein the transmission element, guided on the base body, extends along one of the narrow sides and one of the wide sides towards the movement element and is connected to the movement element.

3. The sun visor according to claim 1, wherein the movement element is connected to the fastening element such that the movement element is movable relative to the fastening element and is connected to the base body.

4. The sun visor according to claim 1, wherein the movement element has a plurality of movement axes, wherein two of the movement axes are aligned at a perpendicular angle.

5. The sun visor according to claim 1, wherein the movement element has a housing with a housing portion, wherein the housing has a rotating sleeve in one housing portion and a rotating element in another housing portion.

6. The sun visor according to claim 5, wherein the one housing portion of the housing which houses the rotating element is connected to the fastening element.

7. The sun visor according to claim 1, wherein the movement element has an end stop on a side of a movement element side, which end stop has a groove and receptacles on its outer wall and is in displaceable communication with the transmission element.

8. The sun visor according to claim 1, wherein the movement element has locking elements which cooperate with an end stop on the movement element side.

9. The sun visor according to claim 1, wherein the transmission element is fixed to an end stop on an actuating-mechanism side by an end which is oriented towards the actuating mechanism and to an end stop on the movement element side by its end which is oriented towards the movement element.

10. The sun visor according to claim 1, wherein the transmission element has, at an end which is oriented towards the actuating mechanism, an energy-storage mechanism in the form of a spring element and at the end which is oriented towards the movement element, likewise an energy-storage element, wherein the energy-storage element on the actuating-mechanism side is arranged between two spring abutments, and wherein the energy-storage mechanism on the movement-element side abuts against an end stop on the movement-element side and a spring abutment.

11. A sun visor for a motor vehicle, the sun visor comprising:
a base body with wide sides extending in a vehicle transverse direction and narrow sides arranged at an angle to the wide sides;
a fastening element configured to be fastened to a component of the motor vehicle in a positionally stable manner;
a movement element connected to the fastening element, wherein the movement element is movable relative to the fastening element and is connected to the base body, wherein the movement element has a plurality of movement axes, and wherein two of the movement axes are aligned at a perpendicular angle;
an actuating mechanism provided on the base body arranged on one of the narrow sides of the base body arranged opposite the movement element, and a transmission element operatively connected to the actuating mechanism, wherein the transmission element is guided on the base body and extends towards the movement element and is connected to the movement element, and wherein the transmission element, guided on the base body, extends along one of the narrow sides and one of the wide sides towards the movement element and is connected to the movement element.

12. The sun visor according to claim 11, wherein the movement element has a housing with a housing portion, wherein the housing has a rotating sleeve in one housing portion and a rotating element in another housing portion.

13. The sun visor according to claim 12, wherein the one housing portion of the housing which houses the rotating element is connected to the fastening element.

14. The sun visor according to claim 13, wherein the movement element has an end stop on a side of a movement-element side, which end stop has a groove and receptacles on its outer wall and is in displaceable communication with the transmission element.

15. The sun visor according to claim 14, wherein the movement element has locking elements which cooperate with the end stop on the movement-element side.

16. The sun visor according to claim 15, wherein the transmission element is fixed to an end stop on an actuating-mechanism side by an end which is oriented towards the actuating mechanism and to the end stop on the movement element side by its end which is oriented towards the movement element.

17. A motor vehicle comprising:
a vehicle body component; and
a sun visor comprising:
a base body with wide sides extending in a vehicle transverse direction and narrow sides arranged at an angle to the wide sides;
a fastening element configured to be fastened to the vehicle body component of the motor vehicle in a positionally stable manner;
a movement element coupled to the base body and the fastening element;
an actuating mechanism provided on the base body; and
a transmission element operatively connected to the actuating mechanism, wherein the transmission element is guided on the base body and extends towards the movement element and is connected to the movement element.

18. The motor vehicle according to claim 17, wherein the actuating mechanism is arranged on one of the narrow sides of the base body arranged opposite the movement element, wherein the transmission element, guided on the base body, extends along one of the narrow sides and one of the wide sides towards the movement element and is connected to the movement element.

19. The motor vehicle according to claim 18, wherein the movement element is connected to the fastening element such that the movement element is movable relative to the fastening element and is connected to the base body.

20. The motor vehicle according to claim 19, wherein the movement element has a plurality of movement axes, wherein two of the movement axes are aligned at a perpendicular angle.
